(19) United States
(12) Patent Application Publication
(10) Pub. No.: US 2010/0281425 A1
(43) Pub. Date: Nov. 4, 2010

(54) HANDLING AND DISPLAYING OF LARGE FILE COLLECTIONS

(75) Inventors: Juha Vartiainen, Espoo (FI); Jens Wilke, Helsinki (FI); Marko Saari, Espoo (FI); Vilja Kaarina Helkio, Espoo (FI); Martin Schuele, Tampere (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/432,925

(22) Filed: Apr. 30, 2009

(51) Int. Cl. G06F 3/048

(52) U.S. Cl. 715/810

(57) ABSTRACT

An apparatus comprising a controller. The controller is configured to display a collection of representations each corresponding to a tag value and to receive input selecting one or more representations. The controller is further configured to assign a size and/or position of a representation according to a frequency of use and/or a time since last used for said corresponding tag value.

### TECHNICAL FIELD

The present application relates to a user interface, an apparatus and a method for improved handling of large file collections, and in particular to a user interface, an apparatus and a method for improved displaying and sorting of large file collections.

### BACKGROUND

Contemporary apparatuses are equipped with large memories. These memories are more and more commonly used to store large file collections of media files such as music, image and video files for example.

These file collections sometimes consist of several thousands of files and it is very difficult for a user to find a specific file unless he knows its exact name. An efficient way of handling these large file collections is thus needed.

Traditionally such files are sorted by name and in folders. This usually generates a folder structure that is most often difficult to overlook.

An apparatus that allows easy and efficient handling of large file collections would thus be useful in modern day society.

### SUMMARY

On this background, it would be advantageous to provide a user interface, an apparatus and a method that overcomes or at least reduces the drawbacks indicated above by providing an apparatus, a method, a computer readable medium and a user interface according to the claims.

By realizing that a clever arrangement of tag values on a display allows for faster input as the most used tags are positioned were a user is most prone to look and/or by adapting the size of the tag's representations to make the most used tags more easy to both find and to input a faster and more easy to use user interface method is achieved for use in an apparatus, a method, user interface or computer readable medium is achieved which allows a user to find or sort a sub collection of files more easily and more intuitively.

Further objects, features, advantages and properties of device, method and computer readable medium according to the present application will become apparent from the detailed description.

### BRIEF DESCRIPTION OF THE DRAWINGS

In the following detailed portion of the present description, the teachings of the present application will be explained in more detail with reference to the example embodiments shown in the drawings, in which:

FIG. 1 is an overview of a telecommunications system in which a device according to the present application may be used according to an example embodiment,

FIGS. 2a and b are views of each an apparatus according to an example embodiment,

FIG. 3 is a block diagram illustrating the general architecture of an apparatus of FIG. 2 in accordance with the present application,

FIG. 4a to g are screen shot views of an apparatus according to an example embodiment,

FIG. 5a to c are screen shot views of an apparatus according to an example embodiment,

FIG. 6 is a flow chart describing a method according to an example embodiment of the application.

### DETAILED DESCRIPTION

In the following detailed description, the user interface, the apparatus, the method and the software product according to the teachings for this application in the form of a cellular/mobile phone will be described by the embodiments. It should be noted that although only a mobile phone is described the teachings of this application can also be used in any electronic device such as in portable electronic devices such as laptops, PDAs, mobile communication terminals, electronic books and notepads and other electronic devices offering access to information.

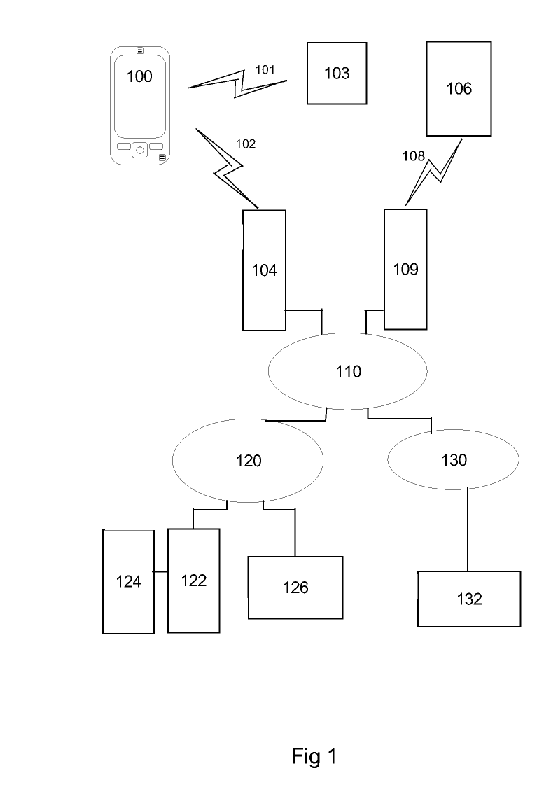

FIG. 1 illustrates an example of a cellular telecommunications system in which the teachings of the present application may be applied. In the telecommunication system of FIG. 1, various telecommunications services such as cellular voice calls, www or Wireless Application Protocol (WAP) browsing, cellular video calls, data calls, facsimile transmissions, music transmissions, still image transmissions, video transmissions, electronic message transmissions and electronic commerce may be performed between a mobile terminal 100 according to the teachings of the present application and other devices, such as another mobile terminal 106 or a stationary telephone 132. It is to be noted that for different embodiments of the mobile terminal 100 and in different situations, different ones of the telecommunications services referred to above may or may not be available; the teachings of the present application are not limited to any particular set of services in this respect.

The mobile terminals 100, 106 are connected to a mobile telecommunications network 110 through Radio Frequency (RF) links 102, 108 via base stations 104, 109. The mobile telecommunications network 110 may be in compliance with any commercially available mobile telecommunications standard, such as Group Spéciale Mobile (GSM), Universal Mobile Telecommunications System (UMTS), Digital Advanced Mobile Phone system (D-AMPS), The code division multiple access standards (CDMA and CDMA2000), Freedom Of Mobile Access (FOMA), and Time Division-Synchronous Code Division Multiple Access (TD-SCDMA).

The mobile telecommunications network 110 is operatively connected to a wide area network 120, which may be Internet or a part thereof. An Internet server 122 has a data storage 124 and is connected to the wide area network 120, as is an Internet client computer 126. The server 122 may host a www/wap server capable of serving www/wap content to the mobile terminal 100.

A public switched telephone network (PSTN) 130 is connected to the mobile telecommunications network 110 as is commonly known by a skilled person. Various telephone terminals, including the stationary telephone 132, are connected to the PSTN 130. The mobile terminal 100 is also capable of communicating locally via a local link 101 to one or more local devices 103. The local link can be any type of link with a limited range, such as Bluetooth, a Universal Serial Bus (USB) link, a Wireless Universal Serial Bus (WUSB) link, an IEEE 802.11 wireless local area network link, a Radio Standard link for example an RS-232 serial link, etc. The local devices 103 can for example be various sensors that can communicate measurement values to the mobile terminal 100 over the local link 101.

A computer such as a palmtop can also be connected to the network both via a radio link such as a WiFi link, which is the popular term for a radio frequency connection using the WLAN (Wireless Local Area Network) standard IEEE 802.11.

It should be noted that the teachings of this application are also capable of being utilized in an internet network of which the telecommunications network described above may be a part.

As is commonly known the internet is a global system of interconnected computer networks that interchange data by packet switching using the standardized Internet Protocol Suite (TCP/IP). It is a “network of networks” that consists of millions of private and public, academic, business, and government networks of local to global scope that are linked by copper wires, fiber-optic cables, wireless connections, and other technologies.

The Internet carries various information resources and services, such as electronic mail, online chat, online gaming, file transfer and file sharing, and the inter-linked hypertext documents and other resources of the World Wide Web (WWW).

It should be noted that even though the teachings herein are described solely to wireless networks it is in no respect to be limited to wireless networks as such, but it to be understood to be usable in the Internet or similar networks. The teachings herein find use in any device having a touch input user interface where other input means, such as keyboards and joysticks, are limited. Examples of such devices are mobile phones, Personal digital Assistants (PDAs), game consoles, media players, personal organizers, electronic dictionaries and digital image viewers.

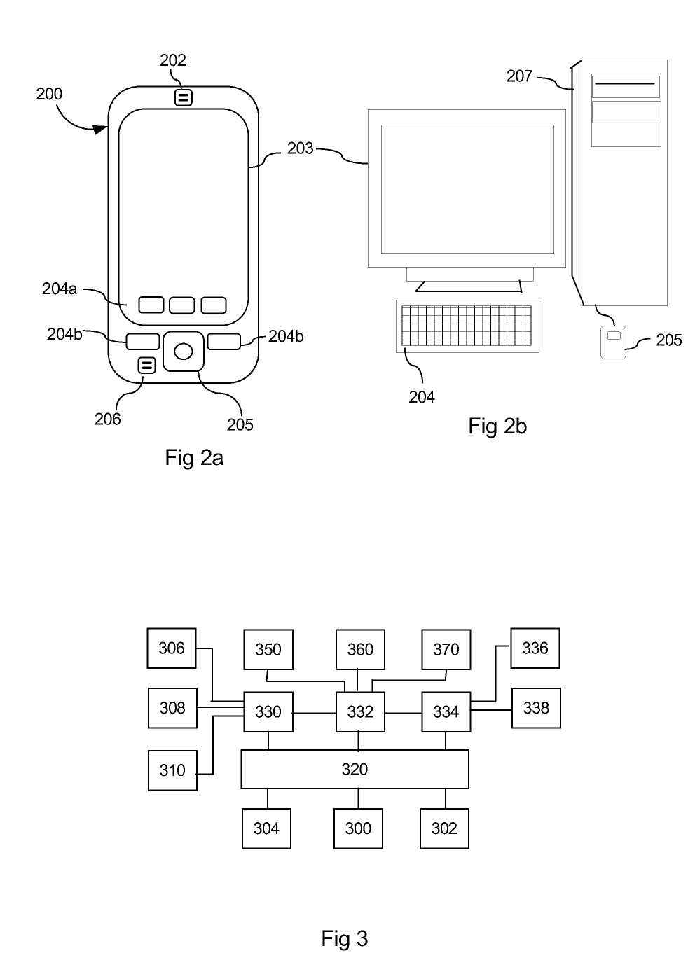

An embodiment 200 of the apparatus in the form of a mobile terminal 100, 200 is illustrated in more detail in FIG. 2a. The mobile terminal 200 comprise a main or first display 203 which in this embodiment is a touch display, a microphone 206, a loudspeaker 202 and a key pad 204 comprising both virtual keys 204a and softkeys or control keys 204b and 204c. The apparatus also comprises a navigation input key such as a five-way key 205.

Another embodiment of the apparatus 100 in the form of a computer 200 is illustrated in more detail in FIG. 2b.

The computer 200 has a display 203, a keypad 204 and a cabinet 207 in which a controller and a memory are housed. It should be noted that the cabinet 207 and the display 203 may be incorporated in the same unit. It should also be noted that the keypad 204 may also be integrated in the same unit as either the display 203 and/or the cabinet 207. The computer 200 also has a navigational input means which in this embodiment is a so-called mouse pointer 205. Other navigational input means such as touch pads or touch screens are also possible. It should be noted that the navigational means may be incorporated into the same unit as the keypad 205, the cabinet, 207 and/or the display 203.

The computer 200 can be connected to a network as in FIG. 1 through either a direct dial-up connection, a Local Area Network connection (LAN) or through an internet connection.

Internet is a global network of interconnected computers, enabling users to share information along multiple channels. Typically, a computer that connects to the Internet can access information from a vast array of available servers and other computers by moving information from them to the computer's local memory. The same connection allows that computer to send information to servers on the network; that information is in turn accessed and potentially modified by a variety of other interconnected computers. A majority of widely accessible information on the Internet consists of inter-linked hypertext documents and other resources of the World Wide Web (WWW). Computer users typically manage sent and received information with web browsers; other software for users' interface with computer networks includes specialized programs for electronic mail, online chat, file transfer and file sharing.

The movement of information in the Internet is achieved via a system of interconnected computer networks that share data by packet switching using the standardized Internet Protocol Suite (TCP/IP). It is a “network of networks” that consists of millions of private and public, academic, business, and government networks of local to global scope that are linked by copper wires, fiber-optic cables, wireless connections, and other technologies.

The internal component, software and protocol structure of the apparatus 200 will now be described with reference to FIG. 3. The apparatus has a controller 300 which is responsible for the overall operation of the mobile terminal and may be implemented by any commercially available CPU (“Central Processing Unit”), DSP (“Digital Signal Processor”) or any other electronic programmable logic device. The controller 300 has associated electronic memory 302 such as Random Access Memory (RAM), Read Only Memory (ROM), Electrically Erasable Programmable Read-Only Memory (EEPROM), flash memory, or any combination thereof. The memory 302 is used for various purposes by the controller 300, one of them being for storing data used by and program instructions for various software in the mobile terminal. The software includes a real-time operating system 320, drivers for a man-machine interface (MMI) 334, an application handler 332 as well as various applications. The applications can include a message text editor 350, a notepad application 360, as well as various other applications 370, such as applications for voice calling, video calling, sending and receiving messages such as Short Message Service (SMS), Multimedia Message Service (MMS) or email, web browsing, an instant messaging application, a phone book application, a calendar application, a control panel application, a camera application, one or more video games, etc. It should be noted that two or more of the applications listed above may be executed as the same application.

The MMI 334 also includes one or more hardware controllers, which together with the MMI drivers cooperate with the touch display 336/203, and the keypad 338/204 as well as various other Input/Output devices such as microphone, speaker, vibrator, ringtone generator, LED indicator, etc.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310 for local connectivity. The RF interface 306 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, band pass filters, amplifiers, mixers, local oscillators, low pass filters, Analog to Digital and Digital to Analog (AD/DA) converters, etc.

The mobile terminal also has a Subscriber Identity Module (SIM) card 304 and an associated reader. As is commonly known, the SIM card 304 comprises a processor as well as local work and data memory.

For large collections of files it is sometimes necessary to sort the file on sorting options. A common kind of sorting options are tags which are a descriptive (often text) value assigned to a file. A user is then able to sort the file collection using these tags to find a specific file more easily. The tags can be either pre-determined or user specified and are usually of a more personal or subjective nature and usually relates to areas of interest.

A controller 300 of an apparatus 200 is configured to sort a file collection using a (collection of) tag values.

To be able to sort depending on a tag it is necessary to assign tag values to a file or possibly, as will be discussed in detail below, to a group of files.

A controller 300 of an apparatus is configured to receive a tag value and to assign it to a file.

It is thus of great use to be able to input tag values easily and efficiently.

In some cases a file is already associated with one or more tag values as tag values may be stored with a file as meta data.

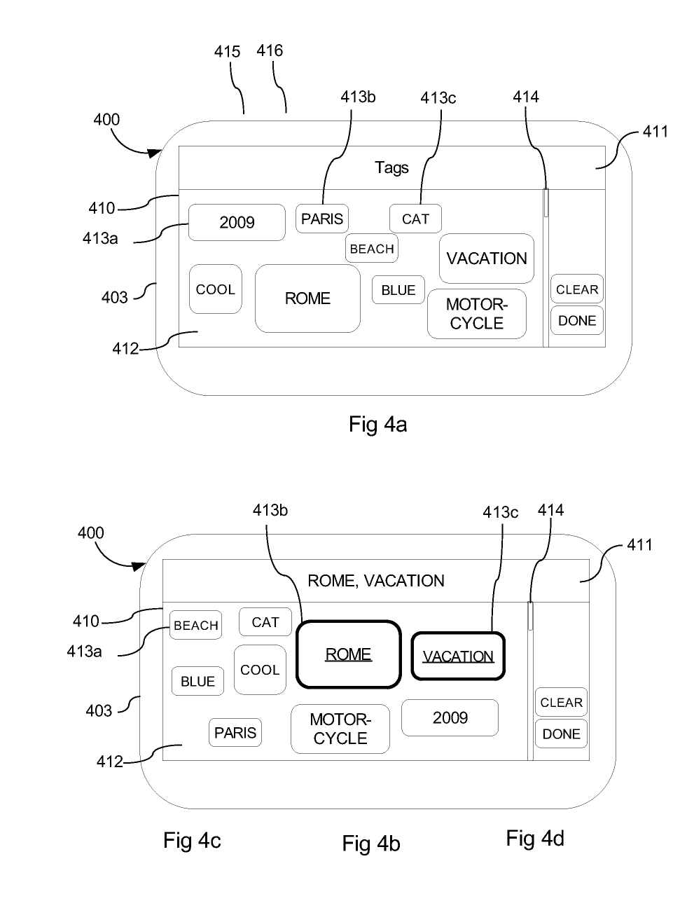

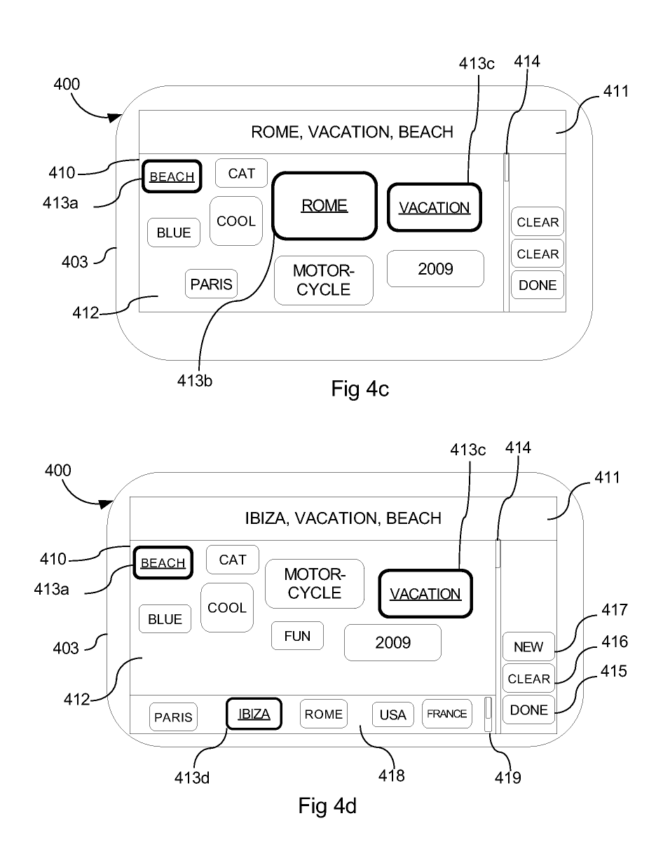

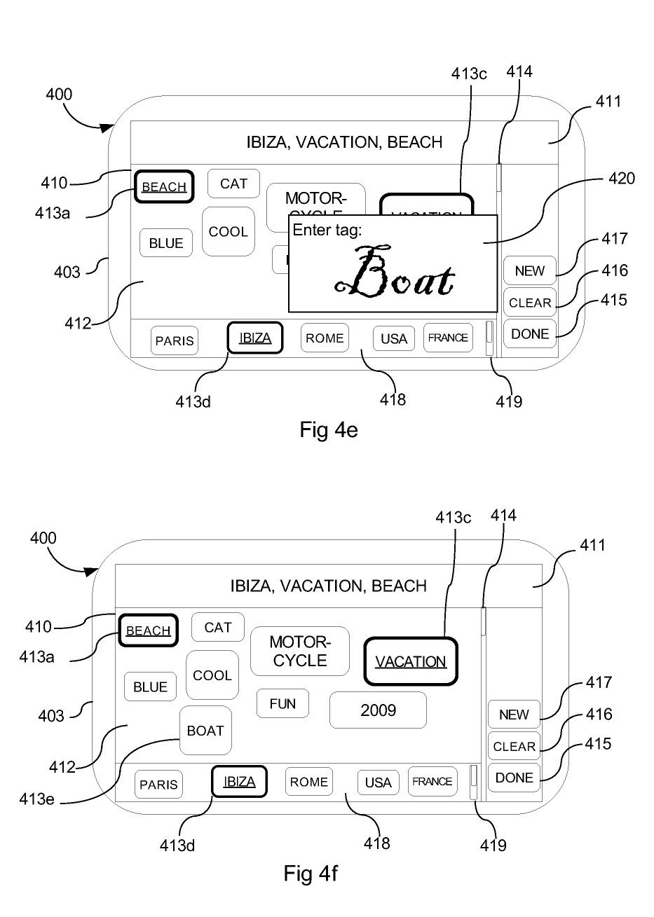

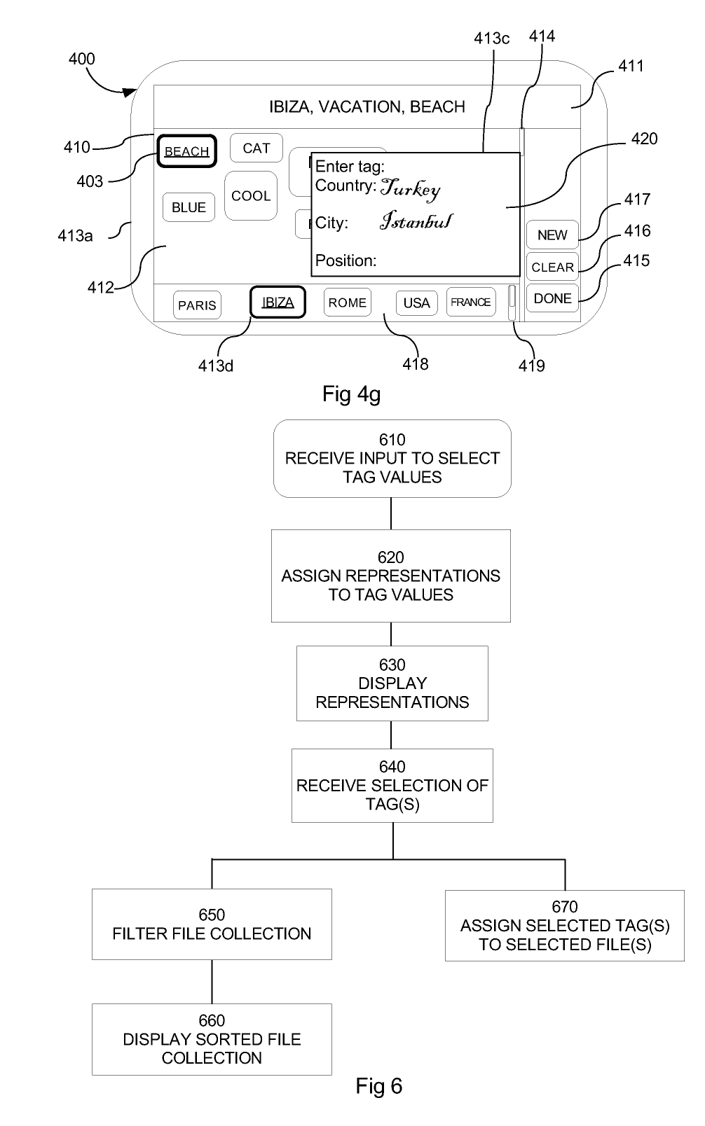

FIG. 4 show a screen shot view 403 of an apparatus 400. It should be noted that such an apparatus is not limited to a mobile phone or a computer. In particular such an apparatus 400 is capable of storing a collection of files, such as media files.

In the following description it will be assumed that the display is a touch display and that a tap is performed with a stylus or finger or other touching means tapping on a position on the display. It should be noted that a tap may also be included by use of other pointing means such as a mouse or touch pad controlled cursor which is positioned at a specific position and then a clicking action is performed. This analogy is commonly known in the field and will be clear to a skilled person. In the description it will be assumed that a tap input comprises a clicking action at an indicated position.

As will be discussed below the varying shape and size of a tag icon allows for easy access especially when used with touch input where the size of the selected object is important for easy access.

Examples of such apparatuses are computers, media players, mobile phones, personal digital assistants (PDA), digital cameras, navigation devices such as GPS (Global Positioning System) devices, game consoles end electronic dictionaries.

The apparatus 400 comprises a touch display 403 on which a tag input window 410 is displayed. The size of the tag input window 410 is only an example and different tag input window sizes may be used as will be clear to a skilled person. In this embodiment the tag input window 410 has a description panel 411 in which a text indicating the content of the tag input window 410 is displayed. In this example it reads “Tags”.

In one embodiment a tag display area 412 is displayed. In this tag display area a collection of tags 413 are displayed. In this example they are displayed as objects having a descriptive text.

Other alternatives are to simply display the descriptive text or to display a graphical object indicating the tag (for example a picture of a motorcycle or of Paris).

In this example the tag display window 410 is provided with a scrollbar 414 to enable displaying more tags than can currently be displayed in the tag input window 410.

In one embodiment a controller is configured to display representations of tag values in alphabetical order.

In one embodiment a controller is configured to display representations of tag values in geographical order.

In one embodiment a controller is configured to display representations of tag values related to geographical locations, also called geotags (which will be discussed in greater detail below) in order of country.

In one embodiment a controller is configured to display representations of tag values related to geographical locations, also called geotags (which will be discussed in greater detail below) in order of city.

In one embodiment a controller is configured to display representations of tag values related to geographical locations, also called geotags (which will be discussed in greater detail below), in order of district.

In one embodiment a controller is configured to display representations of one or more most commonly used or favorite tag values in the middle of a tag input value window 410.

In one embodiment a controller is configured to display representations of one or more most commonly used or favorite tag values in the upper left-hand corner of a tag input value window 410.

In one embodiment a controller is configured to display representations of one or more most commonly used or favorite tag values in the upper right-hand corner of a tag input value window 410.

In one embodiment the size of the representation of the tag, in this example the tag objects 413, is dependant on the frequency of use. This allows for easier access to commonly used tags as it will be easier for a user to hit the correct representation and also to find it as it is easer to both see and hit a large representation.

In one embodiment the size of the representation of the tag, in this example the tag objects 413, is dependant on the time since it was last selected. This allows for easier access to commonly used tags as it will be easier for a user to find the latest used tags as those are likely to be used again and as it is easer to both see and hit a large representation.

In the example of FIG. 4a some objects 413 are displayed as being larger than others. Compare for example the tag with the descriptive text “ROME” with the tag with the descriptive text “CAT”.

In one embodiment the position of the representation of the tag, in this example the tag objects 413, is dependant on the frequency of use. This allows for easier access to commonly used tags as it will be easier for a user to find the correct representation as it will be located more centrally. This also allows for fewer movements to input a plurality of commonly used tags.

In one embodiment the position of the representation of the tag, in this example the tag objects 413, is dependant on the time since it was last selected. This allows for easier access to commonly used tags as it will be easier for a user to find the latest used tags as those are likely to be used again and as it will be easier for a user to find the correct representation as it will be located more centrally. This also allows for fewer movements to input a plurality of commonly used tags.

In the example of FIG. 4b a combination of the above is taken into practice and the most frequently used representation, i.e. the tag objects 413, are displayed as both larger and more centered.

In one embodiment the size of the descriptive text is also dependant on frequency of use and/or time since last access. In FIGS. 4a and 4b the text for “BEACH” is significantly smaller than the text for “VACATION”.

In one embodiment the color, illumination and/or font of the representation of the tag, in this example the tag objects 413, is dependant on the frequency of use. This will enable the tag representation to be more easily identified and thus help a user to find it more easily.

To select a tag a user simply taps on the corresponding representation, in this example the correct tag object 413.

In one embodiment a tag representation, such as a tag object 413, is marked as the tag is selected. A tag representation can be marked by highlighting, using different colors, underlining, change of font and by using a different frame or border.

In one embodiment the description panel 411 is updated to indicate which tag or tags that are currently selected. This is particular useful in case the scrollbar is being used to search for and select tag representations such as tag objects 413 that can not all be displayed visibly at the same time.

In the example of FIG. 4b two tag objects are currently selected, namely “ROME” 413b and “VACATION” 413c.

This would allow a user to sort files of images for example to find all images from vacations to Rome, if the tags were being input for a filtering action.

In this example the tag objects 413b and 413c are marked by being underlined and with thicker frames.

Should this not be specific enough a user may select further tags.

In the example of FIG. 4c a user has selected the tag object 413a “BEACH” and the object 413a has been marked and the description panel 411 updated.

It should be noted that the combination of marking and updating of the description panel 411 is used in this example embodiment.

To de-select a tag a user simply taps on a marked tag. For the example of FIGS. 4b and c, tapping again on the tag object 413 “BEACH” would cause a return to situation of FIG. 4b.

As has been mentioned above a tag value may be pre-determined or user defined. They may also be downloaded from a remote apparatus.

In one embodiment at least one of the tag objects 413d relates to a geographical position. These tags are also referred to as geotags.

In one embodiment the tag input window 410 is provided with a geotag window 418 in which all geotags 413d are displayed. In one embodiment the geotag window 418 is provided with a scrollbar 419 so that it can hold more tags than are currently possible to display visually at one time.

In one embodiment a geotag 413d is associated with some additional information. Such information is one or more of the following: Country, City, District, Address, geographical position, altitude. Other alternatives also exist which would be clear to a skilled person.

In one embodiment this additional information is used by the controller when searching on a tag such s a geotag. For example, if a user has selected to filter using a tag “FRANCE” indicating that all files related to France should be displayed then also tags which are associated to France through the additional information would also be displayed. A file having a tag value “PARIS” would thus also be found using the tag value “FRANCE”.

In one embodiment a controller is configured to extract tag values from files and add the tag value to a collection of tag values.

In one embodiment a controller (300) is also configured to receive input representing a new tag value and in response thereto add the tag value to a collection of tag values.

In one embodiment the tag input window 410 is provided with control objects 415, 416, 417. These objects 415, 416, 417 are in this example virtual buttons indicating that the tag selection is finished 415 (“DONE”), that the tag selection is to cleared 4156(“CLEAR”) and that a new tag may be input 417 (“NEW”).

In one embodiment a controller is configured to display an input field 420 if a user selects to input a new tag he simply presses on the virtual button 417 in response thereto. See FIG. 4e.

It should be noted that the size of the input field 420 is dependant on design issues and may partially overlap the tag input window 410, fully overlap the tag input window 410, be positioned adjacent the tag input window 410 or occupy the whole display 403.

In the example of FIG. 4e the input field 420 is displayed as partially overlapping the tag display area 412. In this embodiment the input field 420 is positioned adjacent the virtual button 417 to visually provide a link between the virtual button 417 and the input field 420. In this example the input field 420 is provided with a descriptive text indicating to a user that a tag should be entered.

In one embodiment the controller is configured to receive the tag as input through a keyboard or keypad, either virtual or physical.

In one embodiment the controller is configured to receive the tag as input through voice input device (not shown).

In one embodiment the controller is configured to receive the tag as input through touch input. In one such embodiment the input is received through Hand Writing Recognition. In this example a user has input the word “Boat” by writing it with a stylus or finger and the controller is configured to interpret the writing through hand writing recognition (HWR) and to create a new tag value. The controller is also configured to provide a representation for the new tag value. In FIG. 4f the new tag value is displayed as part of the collection of tag values in the form of a tag value object 413e.

In one embodiment the controller is configured to receive an input which indicates the importance, priority or frequency of use for a newly entered tag value. In this way a user can expressly indicate whether the new tag value should be displayed in a particular manner or not.

In one embodiment a controller is also configured to receive input indicating a new geotag. The controller is configured to display an geotag input field in response to receiving an indication that a geotag should be input. In one such embodiment such an indication is given by a user pressing on a virtual button associated with a function of entering a new geotag. In another embodiment the input field 420 has fields for the additional information to be input as well. See FIG. 4g for an example where a geotag for Istanbul, Turkey is being input. In one embodiment the input field 420 is provided with an icon indicating that additional data may be entered (not shown).

In one embodiment a controller is configured to determine whether a geotag or normal tag is being input by checking how many fields are being input. For the example in FIG. 4g it is possible to detect that a geotag is being input as the additional information is being input.

In one embodiment a controller is configured to extract tag values from files and add the tag value to a collection of tag values. The controller would then scan the file or file collection for any meta data constituting a tag value and add this tag value to the collection of tag values.

Should a tag value occur for many files a controller may be configured to assign size and/or position according to the frequency of use.

In one embodiment a controller is configured to display all tag values associated with any file on the apparatus.

In one embodiment a controller is configured to display all tag values associated with any file in the currently viewed folder.

In one embodiment a controller is configured to display a different set of tag values as a new folder is visited.

In one embodiment a controller is configured to display a same set of tag values as a new folder is visited. In one such embodiment the controller is also configured to display additional tag values as a new folder is visited.

In one embodiment a controller is configured display a tag input window 410 as has been described above and assign or associate the selected tags to a file or a collection of files. In such an embodiment a user is provided with a possibility to select one or more files either before the tags are being input and then select the tag values or after the tag values have been selected and then associate these tag values to the selected file(s).

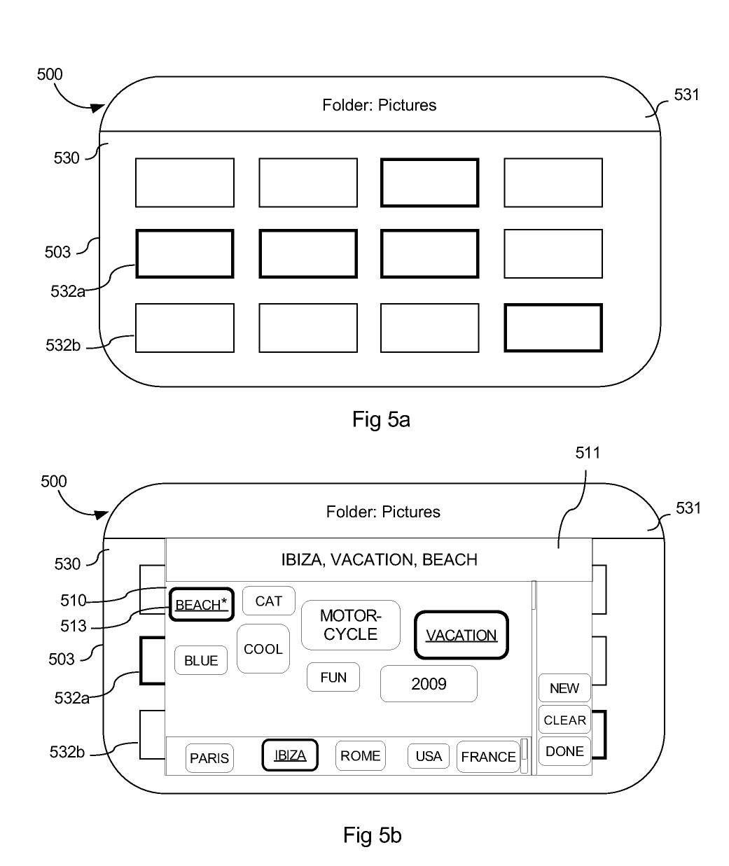

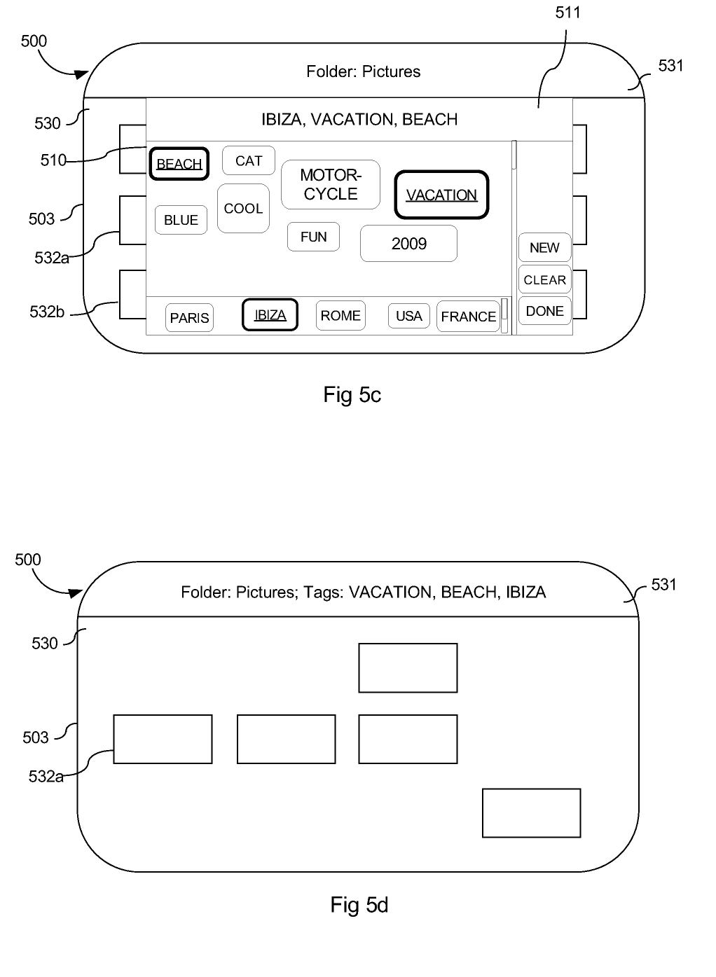

FIG. 5 show a screen shot view 503 of an apparatus 500. It should be noted that such an apparatus is not limited to a mobile phone or a computer. In particular such an apparatus 500 is capable of storing a collection of files, such as media files.

In the following description it will be assumed that the display is a touch display and that a tap is performed with a stylus or finger or other touching means tapping on a position on the display. It should be noted that a tap may also be included by use of other pointing means such as a mouse or touch pad controlled cursor which is positioned at a specific position and then a clicking action is performed. This analogy is commonly known in the field and will be clear to a skilled person. In the description it will be assumed that a tap input comprises a clicking action at an indicated position.

Examples of such apparatuses are computers, media players, mobile phones, personal digital assistants (PDA), digital cameras, navigation devices such as GPS (Global Positioning System) devices, game consoles end electronic dictionaries.

In FIG. 5a folder view 530 comprising a collection of files 532 is displayed. The folder view is provided with a title bar 531. In this example the title bar indicates that which folder is currently being displayed or visited. In this example the folder is “Pictures”.

A user has selected a file 532a. In this example this is indicated by the file 532a having a thicker border. It should be apparent that other ways of indicating a selection of a file should be known to a skilled person.

It should be noted that a plurality of files may be selected at once or one after each other as is commonly known.

In FIG. 5a several files 532 have been selected as can be seen from their marking.

A controller is configured to receive input indicating that a tag value is to be associated with or assigned to the selected file 532a. This input may be provided in a number of ways for example by a double tap on the selection of file(s).

In response thereto a tag input window 510 is displayed, see FIG. 5b. As has been discussed above the size of the tag input window is dependant on a number of design issues.

In one embodiment a controller is configured to indicate whether a tag value is associated with a portion of the file selection and not the whole file selection.

If one or more files in the file selection are already associated with a tag value when the tag input window 510 is displayed these tag values only associated with a portion of the file selection are marked differently than the other marked tag values' representations.

In one embodiment a controller is configured to mark such tag values that are only associated with a portion of a file selection with an asterisk ‘*’ following the descriptive label of the tag values representation. It should be noted that other markings are also possible.

In the example embodiment of FIG. 5b the tag 513 “BEACH” is only associated with a portion of the file selection and is therefore marked with an asterisk.

In one embodiment a controller is configured to receive an input indicating a representation of such a tag value 513 only being associated with a portion of a file selection and in response thereto associate the tag value with the whole file selection. The controller is also configured to update the tag value's representation accordingly. In this example embodiment the asterisk would be removed.

In FIG. 5b a user has selected two more tags: “VACATION” and “IBIZA” as is indicted by their markings.

A description panel 511 has been updated accordingly.

A controller is configured to associate the selected tags with the selection of files(s) 532a.

In one embodiment a controller is configured to receive input that a folder or file collection should be filtered or sorted using a tag or collection of tag values.

In one embodiment this input is provided by a user tapping on the title bar 531.

In response thereto, the controller displays a tag input window 510 in a manner similar to that of FIG. 5b, see FIG. 5c. It should be noted that no files are marked as selected in FIG. 5c. A user may select a set of tag values on which he wishes to sort or filter the file collection on.

In this example embodiment a user has selected three tags: “VACATION”, “BEACH” and “IBIZA” as is indicted by their markings.

A description panel 511 has been updated accordingly.

A controller is configured to sort or filter the file collection accordingly and to update the display.

In FIG. 5d the file collection has been sorted according to the three tags selected in FIG. 5c.

In this embodiment the title bar 531 has been updated by the controller to indicate which tags have been used. This provides a user with a clear indication of which file collection or sub group of file collection he is currently viewing or visiting.

As can be seen in FIG. 5d the files that were associated with the selected tags are the only ones displayed as they are the only ones with the matching tag values.

In one embodiment the controller is configured to sort or filter the file collection on the tag values using a logical AND operation.

In one embodiment the controller is configured to sort or filter the file collection on the tag values using a logical OR operation.

In one embodiment the controller is configured to sort or filter the file collection on the tag values using a combination of logical operations for individual and/or groups of tag values.

In one embodiment a controller is configured to allow a user to indicate which logical operation should be used.

In one embodiment a controller is configured to filter or sort a sub-selection of files on a collection of tag values. In such an embodiment a user may select a plurality of files in a folder and then sort or filter these on the selected tag values.

In one embodiment the apparatus is a mobile communication terminal such as a mobile phone or a personal digital assistant.

In one embodiment the apparatus is a media player.

In one embodiment (as has been described above) the display is a touchdisplay. Utilizing a touchdisplay as above provides for a highly intuitive and easy to access manner of displaying and selecting sorting options that does not require and large stylus movements and in which all control specific data is presented close together for easy overview and correlation.

This allows a user to quickly and efficiently to browse through a large file collection using a set of sorting options and to adapt the sorting options as is needed or wanted without having to access a complicated menu system and in a manner which entices a user to do so and to utilize the sorting options available.

A user is thus offered the possibility of tagging or identifying a sub collection of files for easier reference.

FIG. 6 shows a flowchart of a general method according to the described methods above. In a first step 610 it is indicated that tag values should be selected. A representation is assigned to the available tags in step 620 and these re displayed in step 630. A selection of one or more tag values are received in step 640.

If the tag values have been selected for filtering then a file collection is filtered in step 650 and the matching files are displayed in step 660.

If the tag values have been selected for being associated with a file (or a plurality of files) the selected tags are assigned to the selected file(s) in step 670.

The various aspects of what is described above can be used alone or in various combinations. The teaching of this application may be implemented by a combination of hardware and software, but can also be implemented in hardware or software. The teaching of this application can also be embodied as computer readable code on a computer readable medium. It should be noted that the teaching of this application is not limited to the use in mobile communication terminals such as mobile phones, but can be equally well applied in Personal Digital Assistants (PDAs), game consoles, media players, personal organizers, electronic dictionaries, computers or any other device designed for displaying notifications.

The teaching of the present application has numerous advantages. Different embodiments or implementations may yield one or more of the following advantages. It should be noted that this is not an exhaustive list and there may be other advantages which are not described herein. For example, one advantage of the teaching of this application is that a user is offered an easy way of sorting large file collections.

Although the teaching of the present application has been described in detail for purpose of illustration, it is understood that such detail is solely for that purpose, and variations can be made therein by those skilled in the art without departing from the scope of the teaching of this application.

For example, it should be appreciated that the teachings of the present application may also be applied to various types of electronic devices, such as mobile phones, media players, palmtop computers, laptop computers, desktop computers, workstations, mainframe computers, game consoles, digital cameras, electronic dictionaries and so on. It should also be noted that there are many alternative ways of implementing the methods and apparatuses of the teachings of the present application.

Features described in the preceding description may be used in combinations other than the combinations explicitly described.

Whilst endeavouring in the foregoing specification to draw attention to those features of the invention believed to be of particular importance it should be understood that the applicant claims protection in respect of any patentable feature or combination of features hereinbefore referred to and/or shown in the drawings whether or not particular emphasis has been placed thereon.

The term “comprising” as used in the claims does not exclude other elements or steps. The term “a” or “an” as used in the claims does not exclude a plurality. A unit or other means may fulfill the functions of several units or means recited in the claims.

1. An apparatus comprising a controller, wherein said controller is configured to:
display a collection of representations each corresponding to a tag value; and to
receive input selecting one or more representations.

2. An apparatus according to claim 1, wherein said controller is further configured to assign a size and/or position of a representation according to a frequency of use and/or a time since last used for said corresponding tag value.

3. An apparatus according to claim 1, wherein said tag value corresponds to a graphical position or location.

4. An apparatus according to claim 1, wherein said controller is further configured to receive input representing a tag value;
assign a representation to said tag value; and to
display said representation in response thereto.

5. An apparatus according to claim 1, wherein said controller is configured to search through a collection of files for tag values, assign a representation to said tag value and to display said representation.

6. An apparatus according to claim 1 comprising a touch display and said input is received through a touch input.

7. An apparatus being a mobile communications terminal.

8. An apparatus being a media player.

9. An apparatus comprising:
means for displaying a collection of representations each corresponding to a tag value; and
means for receiving input selecting one or more representations.

10. A computer readable medium comprising at least computer program code for controlling an apparatus, said computer readable medium comprising:
software code for displaying a collection of representations each corresponding to a tag value; and
software code for receiving input selecting one or more representations.

11. A user interface for controlling an apparatus comprising a controller configured to display a collection of representations each corresponding to a tag value and to receive input selecting one or more representations.

12. A method comprising:
displaying a collection of representations each corresponding to a tag value and
receiving input selecting one or more representations.

13. A method according to claim 12 further comprising assigning a size and/or position of a representation according to a frequency of use and/or a time since last used for said corresponding tag value.

14. A method according to claim 12, wherein said tag value corresponds to a graphical position or location.

15. A method according to claim 12 further comprising receive input representing a tag value;
assign a representation to said tag value; and to
display said representation in response thereto.

16. A method according to claim 12 further comprising searching through a collection of files for tag values;
assigning a representation to said tag value; and
displaying said representation.

17. A method according to claim 12 for use in an apparatus comprising a touch display and said input is received through a touch input.

18. A method according to claim 12 for use in an apparatus being a mobile communications terminal.

19. A method according to claim 12 for use in an apparatus being a media player.
